(19) United States
(12) Patent Application Publication
(10) Pub. No.: US 2010/0088901 A1
(43) Pub. Date: Apr. 15, 2010

(54) SNAP-OFF BLADE KNIFE WITH SAFETY STOP

(75) Inventors: James L. Glancey, Blackbird, DE (US); Jack R. Vinson, Penn Valley, PA (US); Daniel Brisach, Oxford, PA (US)

Correspondence Address: RATNERPRESTIA, P.O. BOX 1596, WILMINGTON, DE, 19899, US

(73) Assignee: University of Delaware, Newark, DE (US)

(21) Appl. No.: 12/509,085

(22) Filed: Jul. 24, 2009

Related U.S. Application Data
(60) Provisional application No. 61/083,529, filed on Jul. 25, 2008.

(51) Int. Cl. B26B 1/08; B26B 5/00; B26B 29/02

(52) U.S. Cl. 30/162; 30/164; 30/335

(57) ABSTRACT

A snap-off blade knife having a handle including a proximal portion, a distal portion, and a handle axis extending between the proximal portion and the distal portion is disclosed. The knife also includes a blade slidingly disposed within the handle along the handle axis. The blade comprises a plurality of scored segments. A blade stop fixedly extends from the distal portion of the handle. The blade stop includes a stop arm disposed to engage blade to limit extension of the blade from the handle. A kit comprising the snap-off knife and a blade segment snap-off tool is also disclosed.

### CROSS-REFERENCE TO RELATED APPLICATION

This application claims priority to provisional application number U.S. 61/083,529, filed Jul. 25, 2008, which is incorporated herein, in its entirety, by reference.

### FIELD OF THE INVENTION

The present invention provides a snap-off blade knife having a fixed feature that restricts the amount of the blade that may be extended from the knife handle.

### BACKGROUND OF THE INVENTION

Commercially available snap-off blade knives, sometimes referred to as is box cutters, use a specially designed blade that includes several connected segments, each separated by a score line. This design allows a user to intentionally break off and discard dull segments, thus providing a new, sharp point or edge at the end of the knife blade. Once the dull segment has been removed, the blade may be advanced by the user to fully expose the new point and blade edge from the blade handle. With this design, however, more than one blade segment can be advanced from the blade handle at a time, which may in turn result in inadvertent and/or unintentional breakage of the exposed segments.

### SUMMARY OF THE INVENTION

Briefly, the present invention provides a snap-off blade knife having a handle including a proximal portion, a distal portion, and a handle axis extending between the proximal portion and the distal portion. The knife also includes a blade slidingly disposed within the handle along the handle axis. The blade comprises a plurality of scored segments. A blade stop fixedly extends from the distal portion of the handle. The blade stop includes a stop arm disposed to engage blade to limit extension of the blade from the handle.

The invention further provides a kit including the knife and a blade snap-off tool. The blade snap-off tool includes an elongated body having a tool proximal end and a tool distal end. The body has a slot extending therein from the distal end toward the proximal end.

The invention also provides a snap-off blade knife comprising a handle having a proximal portion, a distal portion, and a handle axis extending between the proximal portion and the distal portion. A blade is slidingly disposed within the handle along the handle axis. The blade comprises a plurality of scored segments. The knife also includes means for preventing the blade from extending from the handle farther than a predetermined limit.

### BRIEF DESCRIPTION OF THE DRAWINGS

The foregoing summary, as well as the following detailed description of exemplary embodiments of the invention, will be better understood when read in conjunction with the appended drawings, which are incorporated herein and constitute part of this specification. For the purposes of illustrating the invention, there are shown in the drawings exemplary embodiments of the present invention. It should be understood, however, that the invention is not limited to the precise arrangements and instrumentalities shown. In the drawings, the same reference numerals are employed for designating the same elements throughout the several figures. In the drawings:

FIG. 1 is a side elevational view of a snap-off blade knife with safety stop according to a first exemplary embodiment of the present invention;

FIG. 2 is a side elevational view of a snap-off blade knife with safety stop according to a second exemplary embodiment of the present invention;

FIG. 3 is a perspective view of a snap-off blade knife and blade segment snap-off tool kit, with the blade segment snap-off tool partially engaging a blade segment of the knife;

FIG. 4 is a bar chart comparing average measured side forces required to break a blade segment versus number of exposed cutting blade segments for different snap-off blade knives;

FIG. 5 is an expanded view of a blade safety kit, consisting of a rigid safety blade stop, adhesive, and a knife with an extendable blade; and

FIG. 6 is an expanded view of a blade safety kit, consisting of a rigid safety blade stop, shrink tubing, and a knife with an extendable blade.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the disclosure without departing from the invention. As used herein, the term “proximal” is intended to mean a direction closer to a user of the inventive knife, and the term “distal” is intended to mean a direction farther from the user of the inventive knife.

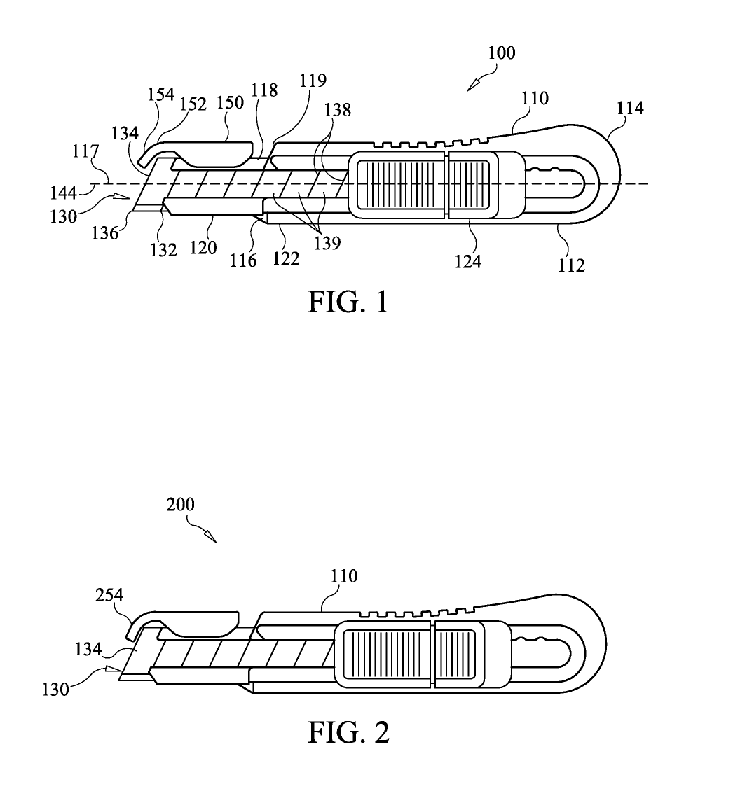

Referring to FIGS. 1-3 in general, a snap-off blade knife according to exemplary embodiments of the present invention provides a mechanism for ensuring that the blade of the knife may be extended no farther than a predetermined limit, reducing the likelihood of inadvertent breakage of the blade when the blade is extended from the handle of the knife.

Referring specifically to FIG. 1, a snap-off blade knife 100 (“knife 100”) according to an exemplary embodiment of the present invention is illustrated. Knife 100 includes a handle 110 and a blade assembly 130 that is slidingly disposed within handle 110. Knife 100 also includes a rigid blade stop 150 that is fixedly coupled to handle 110. Blade stop 150 limits extension of blade 130 from handle 110 such that, if a user attempts to extend blade 130 further than a predetermined distance from handle 110, blade 130 will engage blade stop 150, thus limiting any further advancement of blade 130 from handle 110.

Handle 110 includes a generally elongated handle body 112 that has a proximal portion 114, a distal portion 116, and a handle axis 117 that extends between proximal portion 114 and distal portion 116.

Handle 110 further includes an upper blade track 118, which extends distally from an upper portion 119 of distal portion 116 of handle 110, and a lower blade track 120, which extends distally from a lower portion 122 of distal portion 116 of handle 110. Blade 130 rides along handle 110 between upper and lower blade tracks 118, 120.

Handle 110 also includes a blade advance slider 124, which is coupled to blade 130 and is mounted for sliding movement between upper and lower blade tracks 118, 120. Blade advance slider 124 is used to advance and retract blade 130 out of and into handle 110.

Blade 130 is generally elongated, with a sharp cutting edge 132. An exposed side 134 adjacent to cutting edge 132 extends obliquely from cutting edge 132 at an angle of about 60 degrees. A point 136 is formed at an intersection of cutting edge 132 and exposed side 134.

Blade 130 includes a plurality of score lines 138 that extend from cutting edge 132 generally parallel to exposed side 134. Score lines 138 divide blade 130 into discrete segments 139, and allow blade 130 to be snapped therealong, allowing the snapped off segment of blade 130 to be disposed of, while generating a new exposed side 134. In an exemplary embodiment, a length of blade segment 139 along handle axis 117 between adjacent score lines 138 may be about 5 mm, measured along cutting edge 132. Blade 130 also includes an axis of extension 144 that extends along handle axis 117.

As shown in FIG. 1, while approximately one full segment 139 is shown as extending from distal portion 116 of handle 110, those skilled in the art will recognize that slightly less than one full segment 139, or more than one segment 139 may extend from distal portion 116 of handle 110. It is contemplated, however, that two full segments 139 are not able to be extended from distal portion 116 of handle 110. In an alternative exemplary embodiment, no more than one and a half segments 139 are able to be extended from distal portion 116 of handle 110.

Typically, blade 130 has a thickness of between about 0.6 mm and about 0.7 mm. In order to prevent blade 130 from inadvertently being extended beyond blade stop 150, blade stop 150 may have a thickness of about 3 mm, such that about 1 mm of blade stop 150 extends on either side of blade 130 when blade 130 engages blade stop 150. In an exemplary embodiment, the thickness of blade stop 150 is about four (4) times greater than the thickness of blade 130. The location and thickness of blade stop 150 significantly reduces the likelihood that blade 130 will be able to be extended beyond blade stop 150.

While an exemplary blade 130 used in the embodiments described above has a height along exposed side 134 of about 9 mm, those skilled in the art will recognize that knives using blades having exposed side heights of different sizes, such as, for example, 18 mm, 25 mm, or other sizes, are within the scope of the present invention.

Blade stop 150 extends distally from upper blade track 118. Blade stop 150 includes a longitudinal portion 152 that extends from upper blade track 118 of handle 110 parallel to the axis of extension 144. A stop arm 154 extends obliquely from longitudinal portion 152 relative to axis of extension 144. Longitudinal portion 152 is sufficiently long such that blade 130 may be extended along axis of extension 144 from handle 110 only sufficiently far enough to expose blade 130 from lower blade track 120 a length from point 136 to the first score line 138 before blade 130 engages stop arm 154. Blade stop 150 is a finger-like appendage that provides sufficient clearance so as not to interfere with normal cutting operations with knife 100 or not to interfere with breaking used and/or dull blade segments 139 from blade 130.

In an exemplary embodiment, stop arm 154 extends from longitudinal portion 152 at an angle such that, when blade 150 engages stop arm 154, blade 130 engages stop arm 154 only with a point contact.

In an alternative exemplary embodiment of a safety knife assembly 200 illustrated in FIG. 2, a stop arm 254 extends generally parallel to exposed side 134 of blade 130 such that, when blade 130 is extended from handle 110, blade 130 engages stop arm 254 with a line contact.

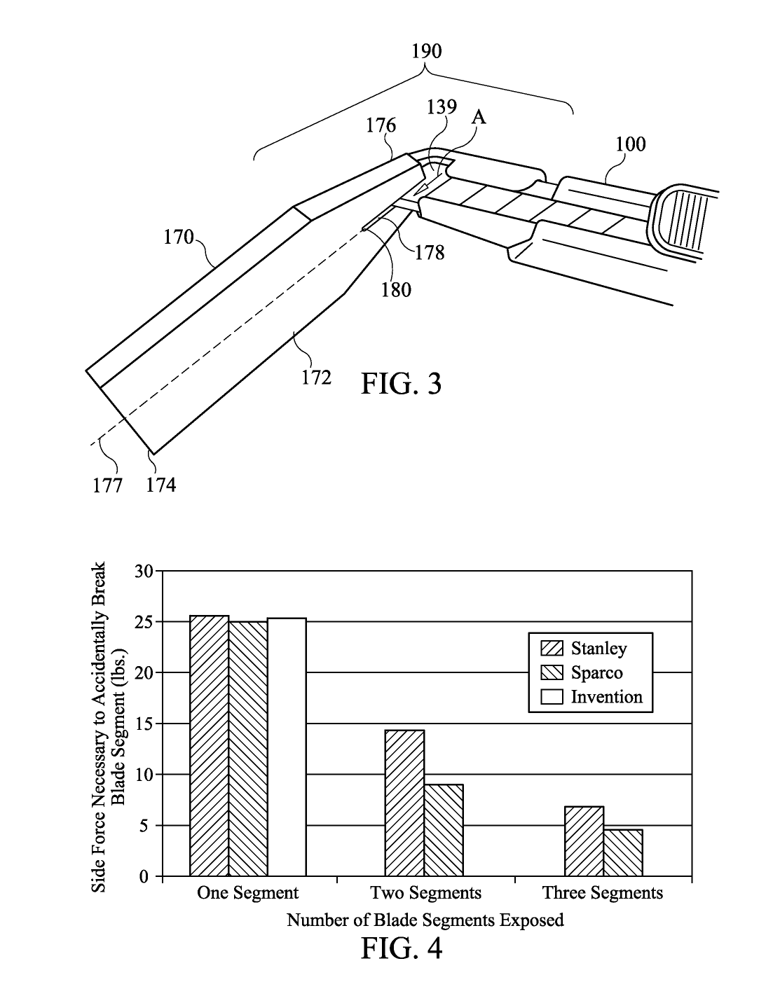

Referring now to FIG. 3, a blade segment snap-off tool 170 may be packaged with knife 100 to form a kit 190. Alternatively, snap-off tool 170 may be integrated into the design of knife 100 as a removable piece.

Blade segment snap-off tool 170 may include a generally elongated body 172 having a proximal end 174 and a distal end 176. A longitudinal segment blade snap-off tool axis 177 extends through body 172 from proximal end 174 to distal end 176. Distal end 176 includes a slot 178 that extends along cutting tool axis 177 from distal end 176 toward proximal end 174. Slot 178 is at least long enough to fully engage the length of exposed side 134 of blade 130. In an exemplary embodiment, slot 178 has a slot length greater than the height of blade 130.

In use, a user grips knife 100 by handle 110 and uses his/her thumb to engage slider 124. Slider 124 is advanced distally along axis of extension 144 such that blade 130 is extended from handle 110 along axis of extension 144. Blade 130 is extended until exposed side 134 engages stop arm 154, allowing only one full segment of blade 130 to be exposed from distal end of lower blade track 120.

Knife 100 may then used to cut a substrate (not shown). When the user determines that the exposed portion of cutting edge 132 is too dull to cut the substrate, the user engages blade segment snap-off tool 170 to break blade 130 along the first score line 138. The user inserts the exposed segment 139 of blade 130 into slot 178 in blade segment snap-off tool 170 along the direction of arrow “A”, as shown in FIG. 3, such that blade 130 is fully inserted into slot 178. While it is desired that blade 130 is fully inserted into slot 178, it is recognized that a small portion of blade 130 may extend away from distal end 176 of blade segment snap-off tool 170 without departing from the scope of the present invention.

As shown in FIG. 3, blade segment snap-off tool slot 178 may have a proximal end 180 that is V-shaped or that otherwise tapers from a first width at or near the distal end of slot 178 to a second, lesser width at or near proximal end 180 of slot 178 so that once the blade snap-off tool 170 engages blade segment 139 and snaps it off, blade segment 139 is at least temporarily retained in slot 178. For example, the first width may be approximately as wide as or slightly wider than the thickness of blade 130 to allow tool 170 to easily slide onto blade 130, and the second width may be smaller than the blade thickness so that blade segment 139 wedges into proximal end 180 of slot 178. The wedged blade segment 139 then may be removed by pulling on the portion of the broken off segment 139 that extends away from the distal end of tool 170, or where tool 170, or at least slot 178, has a width that is less than the length of blade segment 139, by transmitting a distal force to a portion of the wedged blade segment 139 that protrudes from either edge of slot 178 at proximal end 180 of slot 178. Such force may be transmitted by the edge of a trashcan, by a portion of knife 100 itself, or by any other implement retained by the user for this purpose, including another part in the kit provided specifically for this purpose.

Knife 100 may be pivoted relative to cutting tool axis 177 while holding one of knife 100 and blade segment snap-off tool 170 stationary, or, alternatively, while rotating both knife 100 and blade segment snap-off tool 170 about cutting tool axis 177, but in opposite directions. Knife 100 is rotated relative to blade segment snap-off tool 170 until blade 130 snaps along the first score line 138, cutting off the first segment 139 of blade 130. Blade segment snap-off tool 170 is then removed from knife 100, and the snapped off segment 139 of blade 130 may be discarded as described above.

After snapped off segment 139 of blade 130 is discarded, the user may then engage slider 124 to again advance blade 130 distally along axis of extension 144 as discussed above. After user is finished with knife 100, user may retract blade 130 proximally along axis of extension 144 into handle 110 until blade 130 is fully retained within handle 110.

FIG. 4 illustrates a blade safety kit 300 for enabling a user to attach a rigid safety blade stop 350 to a knife 310 that does not already contain a safety blade stop. Blade safety kit 300 may also contain a segment snap-off tool (not shown), such as snap off tool 170 described above. The safety blade stop 350 consists of a longitudinal section 352 for adhering to a non-moving component 312 of knife 310 located adjacent to the non-cutting portion of blade-assembly 330. The blade stop 350, when installed, comprises a stop-arm 354 angled relative to the longitudinal section and positioned to prevent the blade assembly 350 from extending past the first segment 339. As illustrated in FIG. 4, the kit may include an adequate amount of adhesive 360, typically packaged in a tube or other suitable container as it known in the art, for bonding and permanently adhering the rigid blade stop 350 to non-moving component 312. Adhesive may be a two-party epoxy resin, a single part high-strength bonding agent, or any adhesive known in the art for providing a suitable and permanent bond for the materials of construction of the knife. For installation, the user typically prepares the adhesive 360 according to standard instructions for using the adhesive, applies it to the blade stop 350 and/or the non-moving component 312 of the knife 310, and positions the blade stop in the desired position relative to the non-moving component. Prior to final bonding, the user may adjust the blade-stop 350 so that it is centered over the blade assembly 330 and protrudes to the proper length such that only one discrete segment 339 of the blade assembly 330 is exposed.

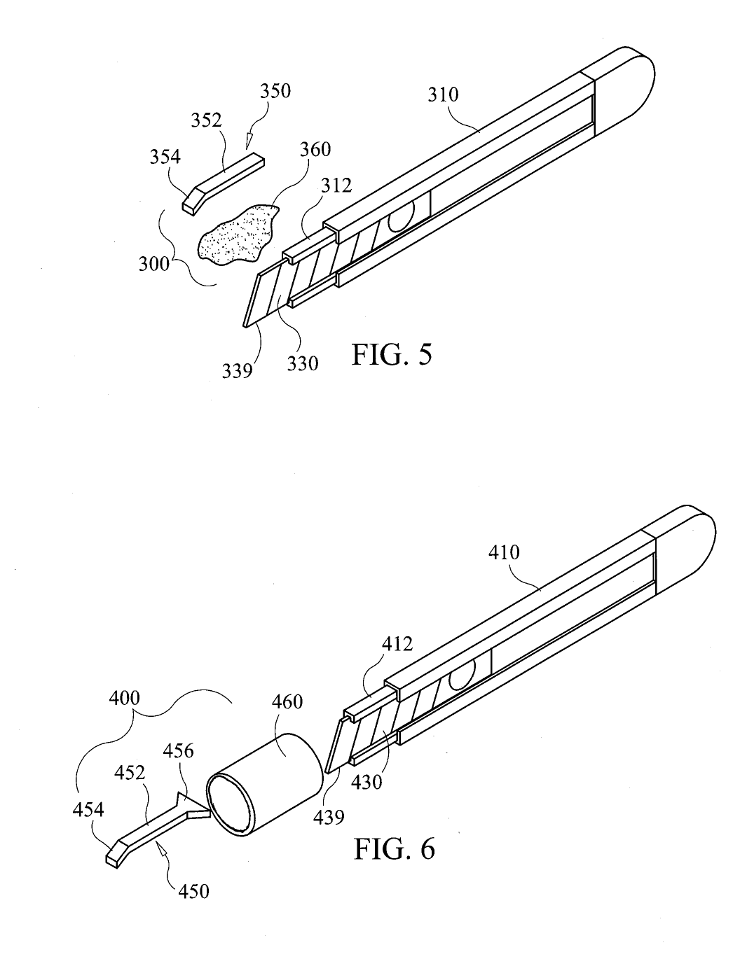

FIG. 5 illustrates another embodiment of a blade safety kit 400 for enabling a user to attach a rigid safety blade stop 450 to a knife 410 that does not already contain a safety blade stop. Blade safety kit 400 may also contain a segment snap-off tool (not shown), such as tool 170 described and illustrated above. Blade stop 450 consists of an angled stop arm 454 and a longitudinal segment 452. The blade stop 450 may comprise a portion thereof, such as but not limited to a fanned tail section 456, having a greater width than the width of stop arm 454 or longitudinal section 452. Shrink tubing 460 is provided with the kit for securing the blade stop 450 to the knife 410. The user secures the blade stop 450 by placing the blade stop on non-moving component 412 of the knife 410 adjacent the non-cutting edge of the knife. The user then slides the shrink tubing 460 around the knife 410 and the rigid blade stop 450. The user then applies heat to the shrink tubing 460 until the tubing 460 shrinks around the blade stop 450 and the knife 410, thereby securing the blade stop 450 in place. The fanned tail section 456 or other wide portion, provides additional stability and further prevents the blade stop 450 from sliding out of the shrink tubing 460. Prior to heating the shrink tubing 460, the user may adjust the blade-stop 450 so that it is centered over the blade assembly 430 and protrudes to the proper length such that only one discrete segment 439 of the blade assembly 430 is exposed.

Although illustrated in FIGS. 4 and 5 with specific mechanisms (adhesive or shrink tubing) for attaching the longitudinal arm to the knife, the invention is not limited to kits comprising such mechanisms. Any mechanism known in the art for permanently or semi-permanently attaching the blade stop to a non-moving portion of the knife with suitable strength is acceptable.

### Examples

Mechanical testing has been conducted to determine an amount of force required to exert on a blade to cause a blade segment fracture. FIG. 4 illustrates side force required to break an exposed blade segment vs. number of blade segments exposed. A knife 100 and a segment blade snap-off tool 170 according to the exemplary embodiments described above, as well as two prior art snap-off blade knives (Prior Art 1 and Prior Art 2) were used in the testing.

For a single exposed blade segment using a knife 100 with a blade stop 150 according to an exemplary embodiment of the present invention or without using a blade stop according to two different embodiments of prior art knives, the measured force necessary to break the segment averaged about 25.5 pounds.

Because the knife according to the present invention does not allow as many as two blade segments to be exposed, the knife according to the present invention was not able to be used for tests with two or three exposed blade segments. For two exposed blade segments using the two prior art knives, the force necessary to break both of the exposed segments together was as low as about 8 pounds. For three exposed blade segments, the force necessary to break all three of the exposed segments was as low as about 4 pounds.

An analysis of variance indicated that the forces measured with two and three exposed blade segments were significantly lower in excess of the 99% confidence level when compared to the force necessary to break a single exposed blade. While the two embodiments of the prior art knives allow a single segment to be exposed, only the present invention includes the fixed stop that prevents more than the single segment to be fully exposed.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A snap-off blade knife comprising:
a handle having a proximal portion, a distal portion, and a handle axis extending between the proximal portion and the distal portion;
a blade slidingly disposed within the handle along the handle axis, the blade comprising a plurality of scored segments; and
a blade stop fixedly extending from the distal portion of the handle, wherein the blade stop includes a stop arm disposed to engage the blade to limit extension of the blade from the handle.

2. The snap-off blade knife according to claim 1, wherein the stop arm of the blade stop is angled relative to the blade to provide a point contact between the stop arm and the blade upon engagement of the blade with the stop arm.

3. The snap-off blade knife according to claim 1, wherein the stop arm of the blade stop is angled relative to the blade to provide a line contact between the stop arm and the blade upon engagement of the blade with the stop arm.

4. The snap-off blade knife according to claim 1, wherein not more than one full scored segment of the blade is extendible between the distal portion of the handle and the blade stop.

5. The snap-off blade knife according to claim 4, wherein the not more than one full scored segment of the blade comprises less than one full scored segment of the blade.

6. The snap-off blade knife according to claim 4, wherein the not more than one full scored segment of the blade comprises more than one full scored segment of the blade, but less than two full scored segments of the blade.

7. The snap-off blade knife according to claim 1, wherein the blade has a blade thickness and the blade stop has a stop thickness, greater than the blade thickness.

8. The snap-off blade knife according to claim 1, wherein the stop thickness is about four times greater than the blade thickness.

9. A kit comprising a snap-off blade knife and a blade segment snap-off tool, the kit comprising:
the snap-off blade knife comprising:
a handle having a proximal portion and a distal portion and a handle axis extending between the proximal portion and the distal portion;
a blade slidingly disposed within the handle along the handle axis, wherein the blade comprises a plurality of scored segments; and
a blade stop fixedly extending from the distal portion of the handle, wherein the blade stop includes a stop arm disposed to engage the blade to restrict extension of the blade from the handle; and
the blade segment snap-off tool including an elongated body having a tool proximal end and a tool distal end, the body having a slot extending therein from the tool distal end toward the tool proximal end for receiving a portion of at least one segment of the blade.

10. The kit according to claim 9, wherein the blade has a blade height and wherein the slot has a slot depth greater than the blade height.

11. A snap-off blade knife comprising:
a handle having a proximal portion, a distal portion, and a handle axis extending between the proximal portion and the distal portion;
a blade slidingly disposed within the handle along the handle axis, wherein the blade comprises a plurality of scored segments; and
means for preventing the blade from extending from the handle farther than a predetermined limit.

12. The snap-off blade knife according to claim 11, wherein the preventing means are fixedly coupled to the handle.

13. The snap-off blade knife according to claim 11, wherein the predetermined limit comprises not more than one full scored segment.

14. A kit for restricting extension of a blade in a snap-off sliding blade knife, the kit comprising:
a blade stop having a longitudinal section for securing to a non-moving portion of the sliding blade knife adjacent a non-cutting portion of the blade, and a stop arm connected to and angled relative to the longitudinal section for engaging and restricting extension of the blade; and
means for securing the blade stop to the non-moving portion of the sliding blade knife.

15. The kit of claim 14, wherein the means for securing the blade stop comprises an adhesive.

16. The kit of claim 15, further comprising a suitable amount of adhesive for securing the safety blade stop.

17. The kit of claim 14, wherein the means for securing the blade stop comprises shrink tubing and the kit further comprises a suitable length of shrink tubing for securing the safety blade stop.

18. The kit of claim 17, wherein the longitudinal section has at least one wide portion having a width greater than a remainder of the longitudinal section.

19. The kit of claim 18, wherein the wide portion is located at an end of the longitudinal section opposite the stop arm end.

20. The kit of claim 14, further comprising a blade segment snap-off tool including an elongated body having a tool proximal end and a tool distal end, the body having a slot extending therein from the tool distal end toward the tool proximal end for receiving a portion of at least one segment of the blade.
